(19) United States
(12) Patent Application Publication
(10) Pub. No.: US 2006/0195360 A1
(43) Pub. Date: Aug. 31, 2006

(54) Electronic coupon system, contribution level calculation method, electronic coupon processing device, and electronic coupon processing program

(75) Inventors: Naoki Watanabe, Tokyo (JP); Takashi Tomiyama, Yokohama-shi (JP); Shigetoshi Kunieda, Kawasaki-shi (JP); Masaki Narahashi, Tokyo (JP); Kozo Ishida, Yokohama-shi (JP)

Correspondence Address: HARNESS, DICKEY & PIERCE, P.L.C., P.O. BOX 828, BLOOMFIELD HILLS, MI, 48303, US

(73) Assignee: Toshiba Tec Kabushiki Kaisha

(21) Appl. No.: 11/363,147

(22) Filed: Feb. 27, 2006

(30) Foreign Application Priority Data
Feb. 28, 2005 (JP) 2005-054760
Nov. 8, 2005 (JP) 2005-323782

(51) Int. Cl. G06Q 30/00

(52) U.S. Cl. 705/14

(57) ABSTRACT

An electronic coupon system adds identification information for specifying users to electronic coupons every time electronic coupons are distributed among users, and when the electronic coupons are used, the identification information added to the electronic coupons are acquired as a distribution history of the electronic coupons distributed among the users. A contribution level of each user is calculated by using the acquired distribution history.

### CROSS-REFERENCE TO RELATED APPLICATIONS

This application is based upon and claims the benefit of priority from prior Japanese Patent Applications No. 2005-054760, filed Feb. 28, 2005; and No. 2005-323782, filed Nov. 8, 2005, the entire contents of both of which are incorporated herein by reference.

### BACKGROUND OF THE INVENTION

1. Field of the Invention

The present invention relates to an electronic coupon system using electronic coupons, a contribution level calculation method, an electronic coupon processing device, and an electronic coupon processing program.

2. Description of the Related Art

Among systems for use in marketing approaches in which an attempt is made to gain sales by indirect information communication such as word-of-mouth communication, there is an electronic coupon system using electronic coupons which grant a special favor such as a discount in order to evoke consumption of purchasers.

As a conventional electronic coupon system, for example, a technology has been known in which, by using a distribution history of electronic coupons which can be distributed among portable terminals of users and which have distribution history information recording parts on which identification information of a user who mediates distribution is recorded, routes of distributors are displayed in a tree form for each issued electronic coupon, and the accumulation of the number of distributions are shown, which specifies users who contribute for distributing the electronic coupons. Further, a technology has been known in which it is possible for a dealer to examine an effective method for issuing electronic coupons by extracting and displaying distribution routes which have led to sales agreements (Jpn. Pat. Appln. KOKAI Publication No. 2003-187140).

In the above-described conventional method, the routes of distributors are displayed in a tree form for each issued electronic coupon, and the number of distributions is shown. However, because evaluation is possible by only the number of distributions, only users contributing to the distribution can be recognized. Accordingly, it is difficult to find at one view trusted customers who distribute electronic coupons and use the electronic coupons by themselves.

### BRIEF SUMMARY OF THE INVENTION

According to one aspect of the present invention, there is provided an electronic coupon system comprising: a plurality of portable terminals which are configured to communicate with one another and which have identification information for specifying users; a server configured to communicate with the portable terminals via a network; a POS terminal configured to communicate with the portable terminals via a short-range radio; and an information terminal configured to communicate with the POS terminal via a network, wherein

the server comprises means for issuing electronic coupons, the portable terminals each comprise means for receiving the electronic coupons issued by the server; means for transmitting and receiving the electronic coupons among the portable terminals; means for newly adding identification information to the electronic coupons every time the portable terminals receive the electronic coupons; the POS terminal comprises means for receiving an electronic coupon to which at least one of the identification information has been added, from the portable terminals; the POS terminal comprises means for acquiring identification information from the electronic coupons, the information terminal comprises means for receiving and storing identification information for the each electronic coupon from the POS terminal; the information terminal comprises means for arraying the stored identification information in order of adding to the electronic coupons for the each electronic coupon; the information terminal comprises means for displaying the arrayed identification information; and means for calculating contribution levels of users who have used the electronic coupons on the basis of the arrayed identification information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram of a marketing system according to one embodiment of the present invention;

FIG. 2 is a schematic diagram of a server in the embodiment;

FIG. 3A is a schematic diagram of a portable terminal in the embodiment;

FIG. 3B is a schematic diagram showing content recorded in a recording device of the portable terminal of FIG. 3A;

FIG. 4 is a schematic diagram of a portable terminal in the embodiment;

FIG. 5 is a schematic diagram of a POS terminal in the embodiment;

FIG. 6 is a schematic diagram of a store computer in the embodiment;

FIG. 7 is a schematic diagram of an electronic coupon in the embodiment;

FIG. 8 is a schematic diagram of a coupon index in the embodiment;

FIG. 9 is a flowchart of operations in which the portable terminal in the embodiment receives an electronic coupon from a server;

FIG. 10 is a flowchart of operations in which the portable terminal in the embodiment transmits an electronic coupon to another portable terminal;

FIG. 11 is a flowchart of operations in which the portable terminal in the embodiment receives an electronic coupon from another portable terminal;

FIG. 12 is a flowchart of operations in which the portable terminal in the embodiment transmits an electronic coupon to the POS terminal to use;

FIG. 13 is a view showing a screen example for confirming storing an electronic coupon in the embodiment;

FIG. 14 is a view showing a screen example for selecting an electronic coupon to be sent in the embodiment;

FIG. 15 is a view showing a screen example for confirming an intention to send an electronic coupon in the embodiment;

FIG. 16 is a flowchart of operations in which the POS terminal in the embodiment receives a coupon from the portable terminal, and transmits data included in the electronic coupon to the store computer;

FIG. 17 is a flowchart of processings to be executed by the store computer in the embodiment;

FIG. 18A shows a history summary table before sorting in the embodiment;

FIG. 18B shows a history summary table after sorting in the embodiment;

FIG. 19 is a flowchart of operations for sorting a history summary table in the embodiment;

FIG. 20A is a table showing a history summary subset in the embodiment;

FIG. 20B is a table showing a contribution level list in the embodiment;

FIG. 20C is a view showing a distribution route tree in the embodiment;

FIG. 21A is a table showing a history summary subset in the embodiment;

FIG. 21B is a table showing a contribution level list in the embodiment;

FIG. 21C is a view showing a distribution route tree in the embodiment;

FIG. 22 is a flowchart of operations for displaying distribution routes in a tree form in the embodiment;

FIG. 23 is a flowchart of operations for providing display flags in the embodiment;

FIG. 24 is a table showing a history summary subset to which display flags have been provided in the embodiment;

FIG. 25 is a flowchart of operations in which the store computer in the embodiment eliminates a line whose histories are repeated from the history summary subset;

FIG. 26A shows the history summary subset in FIG. 25 before changing in the embodiment;

FIG. 26B shows the history summary subset in FIG. 25 after changing in the embodiment;

FIG. 27 is a view showing an intermediate state of operations for connecting among nodes with links in the embodiment;

FIG. 28A is a table showing a history summary subset in the embodiment;

FIG. 28B is a table showing a contribution level list in the embodiment;

FIG. 28C is a view showing the positioning of a customer at a highest contribution level in FIG. 20C;

FIG. 29A is a table showing a history summary subset in the embodiment;

FIG. 29B is a table showing a contribution level list in the embodiment; and

FIG. 29C is a view showing the positioning of a customer at a highest contribution level in FIG. 21C.

### DETAILED DESCRIPTION OF THE INVENTION

Hereinafter, one embodiment of the present invention will be described with reference to the accompanying drawings.

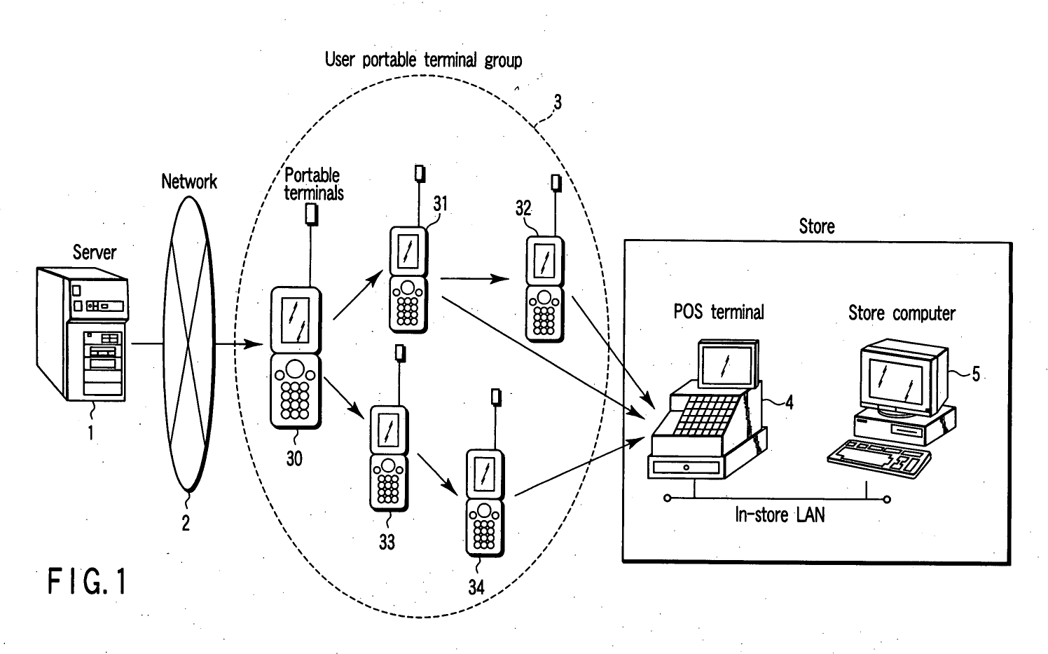

A marketing system which is one embodiment according to the present invention has a configuration as shown in FIG. 1. As shown in FIG. 1, the marketing system is configured by a server 1 which distributes electronic coupons; a network 2 serving as a route through which the electronic coupons are distributed; a user portable terminal group 3 which is an aggregate of portable terminals which receive the electronic coupons; a point-of-sale (POS) terminal 4 (settlement processing device) which receives the electronic coupons in a store and carries out settlement operation; a store computer 5 (electronic coupon processing device) serving as an information terminal which tabulates electronic coupons used in the store and carries out analysis for finding important customers; and an in-store LAN which connects the POS terminal 4 and the store computer 5.

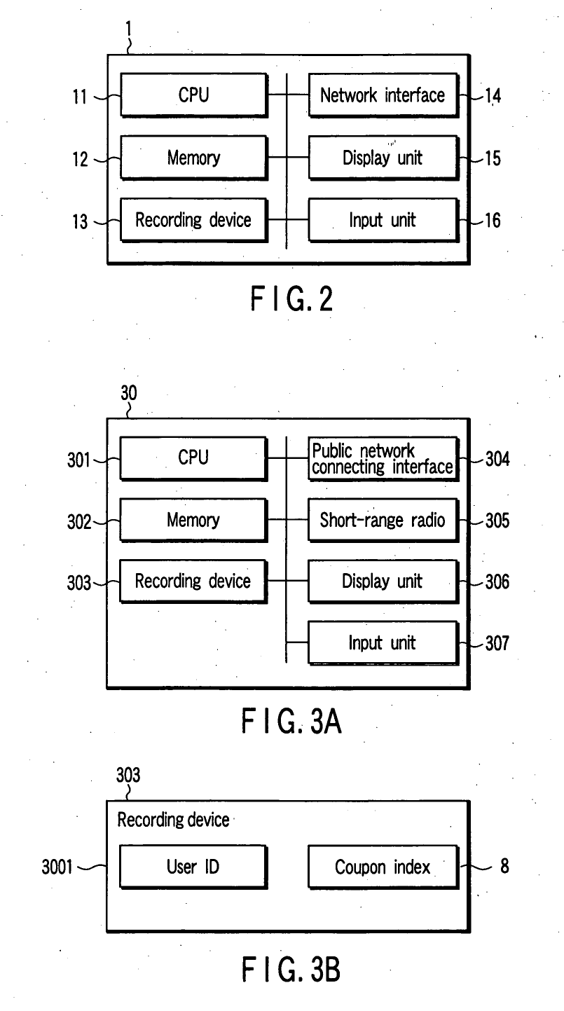

FIG. 2 is a schematic diagram of the server 1. The server 1 is a device for distributing electronic coupons to portable terminals belonging to the user portable terminal group 3. The server 1 is configured by a CPU 11 which manages electronic coupons and executes a program for distributing the electronic coupons in accordance with a request from a service provider; a memory 12 which is a temporary storage region; a recording device 13 for storing the electronic coupons; a network interface 14 for making a connection with the network 2; a display unit 15 for displaying data to be browsed at the time of operating the server 1; and an input unit 16 for carrying out operations of the server 1 or data input.

The network 2 is a network to which the server 1 is connected, and includes Internet and public networks such as mobile telephones.

FIG. 3A is a schematic diagram of a portable terminal 30. The user portable terminal group 3 is an aggregate of the portable terminals 30 to 34 shown in FIG. 1 possessed by a plurality of users who receive the benefit of services of electronic coupons. The portable terminal 30 which is one of the portable terminals belonging to the user portable terminal group 3 is configured by a CPU 301 which executes a program to be executed on the portable terminal 30; a memory 302 which stores data to be temporarily stored in order to execute the program; a recording device 303 which enables reading and writing on the basis of an order from the CPU 301 and records programs or data; a public network connecting interface 304 for making a connection with the server 1 on a public network; a short-range radio 305 for exchanging electronic coupon data by making a connection with another portable terminal 31 or the POS terminal 4; a display unit 306 for displaying a content of an acquired electronic coupon, and displaying a screen for urging an owner of the portable terminal 30 to operate in accordance with a program; and an input unit 307 for operating the portable terminal 30.

FIG. 3B is a schematic diagram showing a content recorded in the recording device 303. Further, the portable terminals 30 to 34 belonging to the user portable terminal group 3 are associated with user IDs for respectively identifying owners, and the user ID 3001 is recorded in the recording device 303. Although not illustrated, when the portable terminal 30 receives an electronic coupon from the server 1 or any one of the other portable terminals 31 to 34, electronic coupon data showing the electronic coupon is stored in the recording device 303, and when a settlement is carried out by using the POS terminal 4 and the aforementioned electronic coupon, the settlement record is recorded in the recording device 303. A coupon index 8 which is a list of electronic coupons recorded in the recording device 303 is also recorded in the recording device 303.

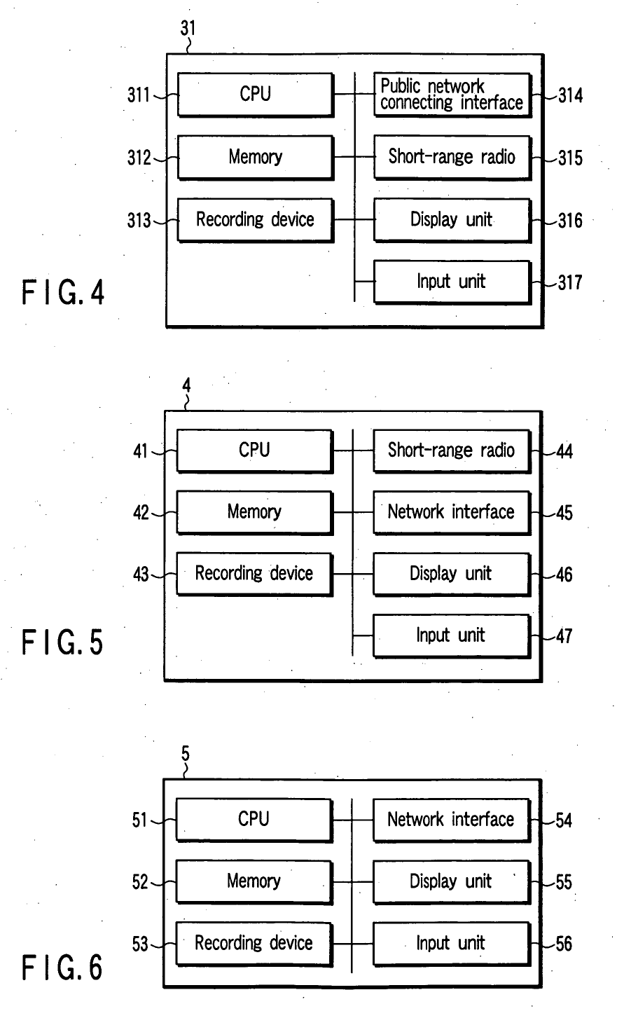

There are a plurality of portable terminals 31 to 34 other than the portable terminal 30 in the user portable terminal group 3, and all of those have the same configuration as that of the portable terminal 30. FIG. 4 is a schematic diagram of the portable terminal 31. Because the other portable terminals 32 to 34 have the same configurations as those of the portable terminals 30 and 31, the illustrations will be omitted.

FIG. 5 is a schematic diagram of the POS terminal 4. The POS terminal 4 is a terminal which settles accounts, and the POS terminal 4 sums up an amount of money of an article purchased by an owner of a portable terminal who is a customer of a store and a discount due to an electronic coupon received from the portable terminal, and charges and settles the bill with respect to the owner of the portable terminal. The POS terminal 4 is configured by a CPU 41 which carries out the calculation for settlement of articles and electronic coupons; a memory 42 which is a temporary storage region; a recording device 43 for recording information on settlement; a short-range radio 44 for receiving an electronic coupon transmitted from the portable terminal 30; a network interface 45 for making a connection with the in-store LAN; a display unit 46 for indicating information on settlement to a clerk or a consumer; and an input unit 47 for an operator to operate the POS terminal 4.

FIG. 6 is a schematic diagram of the store computer 5. The store computer 5 is a device for processing information on an electronic coupon transmitted from the POS terminal 4, and for detecting a portable terminal owner at a high contribution level with respect to purchase in a store on the basis of a state of use for the electronic coupon. The store computer 5 is configured by a CPU 51 for calculating a contribution level; a memory 52 for temporarily storing information; a recording device 53 serving as storing means for storing results of analysis on information; a network interface 54 serving also as receiving means for making a connection with an in-store LAN; a display unit 55 which carries out a tree view which is a result of analysis on electronic coupons; and an input unit 56 for carrying out operations for analysis.

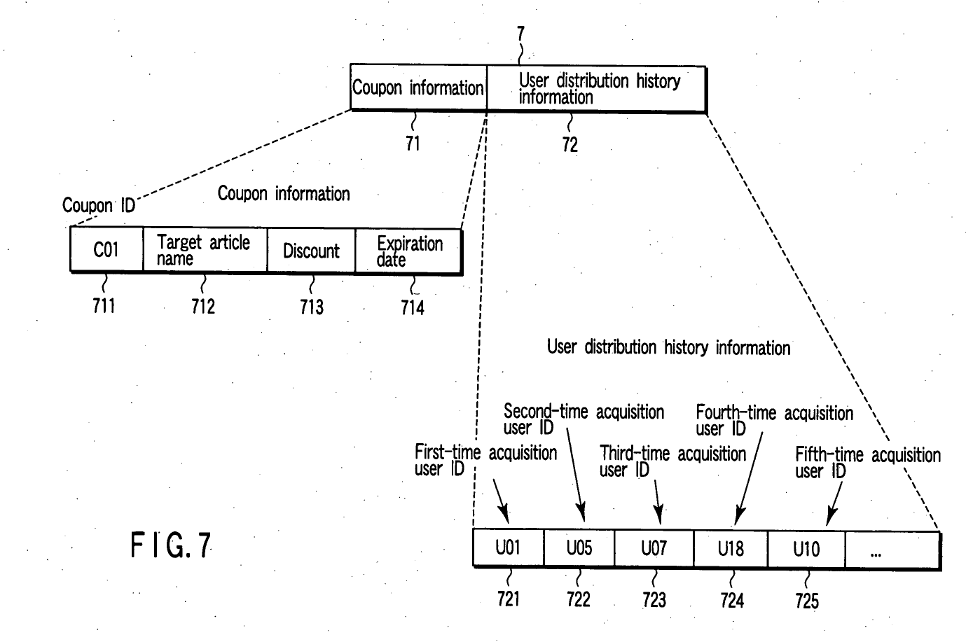

FIG. 7 is a schematic diagram of an electronic coupon 7. The electronic coupon 7 is electronic data which becomes a certificate for providing a special favor to a user, and is allowed to be distributed among portable terminals of users. The electronic coupon 7 is composed of coupon information 71 serving as basic information and user distribution history information 72 showing a history of distributing among the portable terminals 30 to 34 of users. As the basic information included in the coupon information 71, there are a coupon ID 711 which is uniquely allocated to each type of electronic coupon, a target article name 712 for discount of the electronic coupon, a discount 713 at the time of purchasing a target article, and an expiration date 714 of the electronic coupon 7. Moreover, the user distribution history information 72 is composed of successive user IDs which are added to the tail end every time the electronic coupon 7 is distributed to a user, and data are added in the order of acquiring the electronic coupon 7, such as a first-time acquisition user ID 721, a second-time acquisition user ID 722, a third-time acquisition user ID 723, and . . . .

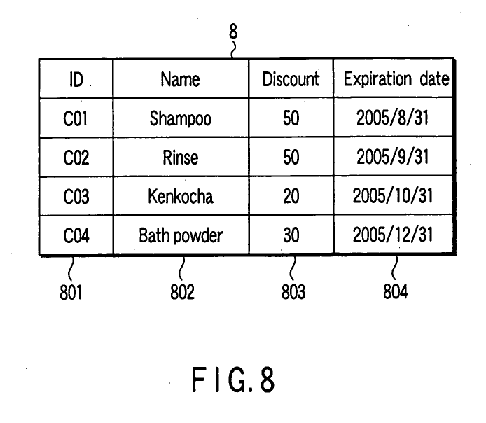

FIG. 8 is a schematic diagram of a coupon index 8. The coupon index 8 is composed of coupon information on zero or more electronic coupons, and each item of coupon information includes a coupon ID 801, a target article name 802 for discount of the coupon, a discount 803 for the target article, and an expiration date 804 of the electronic coupon. For example, as shown in FIG. 8, a target article name (name) “Shampoo”, a discount “50” Yen, and an expiration date “Aug. 31, 2005” (i.e., until Aug. 31, 2005) are set so as to correspond to a coupon ID “C01”.

The server 1 is in a state of being connected to the network 2 via the network interface 14, and records the electronic coupons 7 in the recording device 13. The server 1 retrieves the electronic coupon 7 having coupon information 71 according to a purpose from the recording device 13 at the request of a person who has put coupon service into execution. Then, the server 1 transmits the electronic coupon to, for example, the portable terminal 30 of a specific user among the owners of the portable terminals 30 to 34 belonging to the user portable terminal group 3.

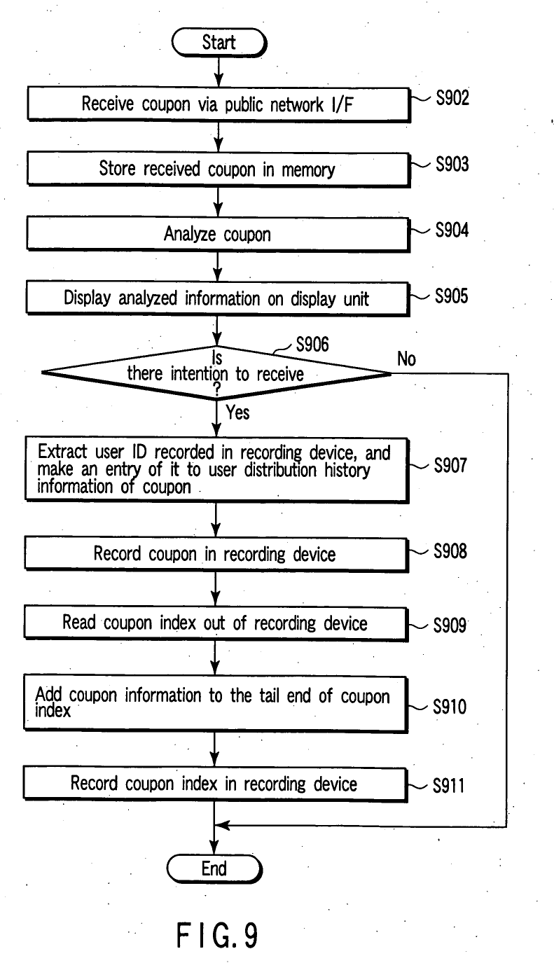

Next, a flow of operations in which the portable terminal 30 receives the electronic coupon 7 will be described with reference to a flowchart of FIG. 9.

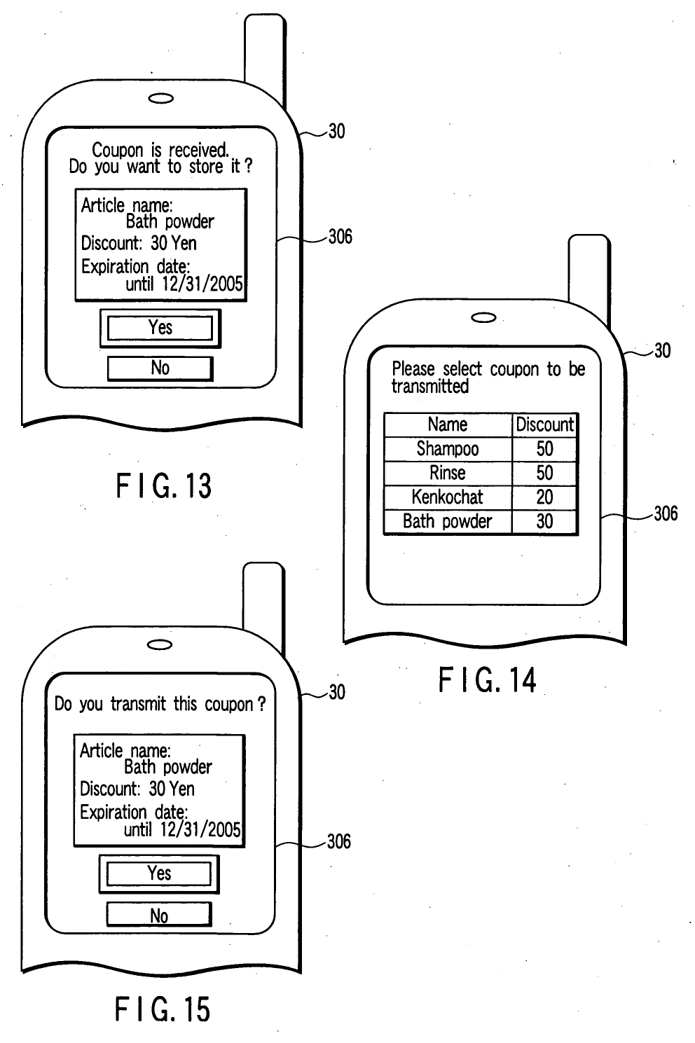

When the electronic coupon 7 is distributed via the network 2 from the server 1 in a standby mode of the portable terminal 30, the portable terminal 30 receives the electronic coupon 7 via the public network connecting interface 304, and stores it temporarily in the memory 302 in steps S902 and S903. In step S904, the CPU 301 analyzes the electronic coupon 7, and extracts the target article name 712, the discount 713, and the expiration date 714 which are included in the coupon information 71. In step S905, those information are displayed on the display unit 307. This makes it possible to confirm whether or not the owner of the portable terminal 30 intends to receive the electronic coupon 7. The confirmation screen is made to be a screen of FIG. 13. When, in step S906, the owner of the portable terminal 30 inputs an instruction showing the intention to receive the electronic coupon 7 on the basis of an operation of the input unit 307 (Yes in step S906), in steps S907 and S908, a user ID 3001 recorded in the recording device 303 is extracted, and the electronic coupon is recorded in the recording device 303 after the user ID is added to the user distribution history information 72 of the electronic coupon 7 temporarily stored in the memory 302. Further, in steps S909 to S911, the coupon index 8 is read out of the recording device 303, the coupon information 71 of the electronic coupon is added to the tail end, and the coupon index 8 is recorded in the recording device 303 again. Namely, the coupon index 8 is read out of the recording device 303 in step S909. In step S910, the coupon information 71 of the electronic coupon 7 is processed to add in the tail end. In step S911, the coupon index 8 is recorded in the recording device 303 again. In case of NO in S906, the routine is completed.

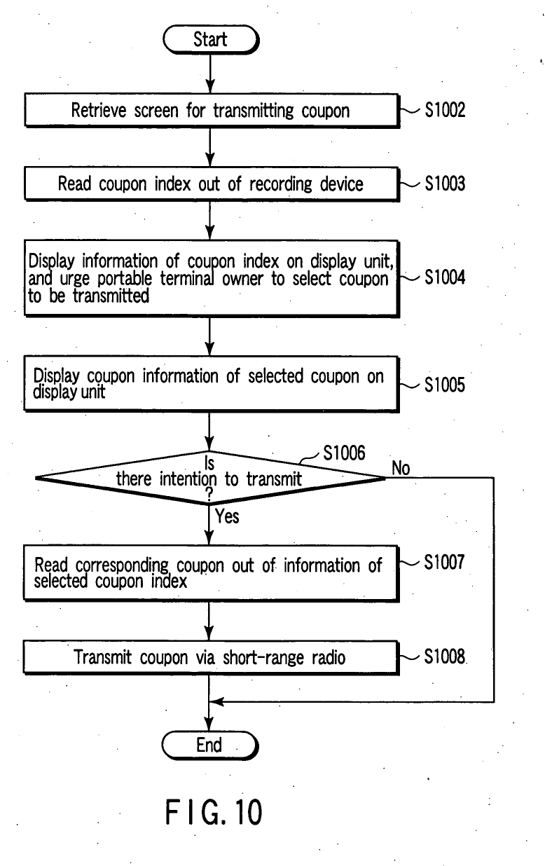

Next, a flow of operations in which the portable terminal 30 transmits an electronic coupon to another portable terminal 31 will be described with reference to a flowchart of FIG. 10.

In a standby mode of the portable terminal 30, a screen for transmitting an electronic coupon is retrieved on the basis of an operation of the input unit 307 by the owner of the portable terminal 30 in step S1002. In step S1003, the coupon indices 8 recorded in the recording device 303 are retrieved, and read onto the display unit 306 out of the recording device 303 when a plurality of types of electronic coupons are stored in the portable terminal 30. In step S1004, all or some of the coupon indices 8 are displayed as shown in FIG. 14. More specifically, a screen for causing the owner of the portable terminal 30 to select an electronic coupon to be transmitted is displayed on the display unit 306. This makes it possible to urge the portable terminal owner to select a coupon to be transmitted. If a selection of an electronic coupon to be transmitted is confirmed when the input unit 307 is operated by the owner of the portable terminal 30, a screen for confirming whether or not there is the intention to transmit the electronic coupon is displayed in step S1005, as shown in FIG. 15, on the display unit 306 on the basis of the information of the coupon index 8. In step S1006, when an instruction showing the intention to transmit the electronic coupon is inputted on the basis of an operation by the owner of the portable terminal 30 (Yes in step S1006), the electronic coupon 7 is read out of the recording device 303 on the basis of a coupon ID recorded in the coupon index 8 in step S1007, and the electronic coupon is transmitted to the short-range radio 315 of the portable terminal 31 via the short-range radio 305 in step S1008. In case of NO in S1006, the routine is completed.

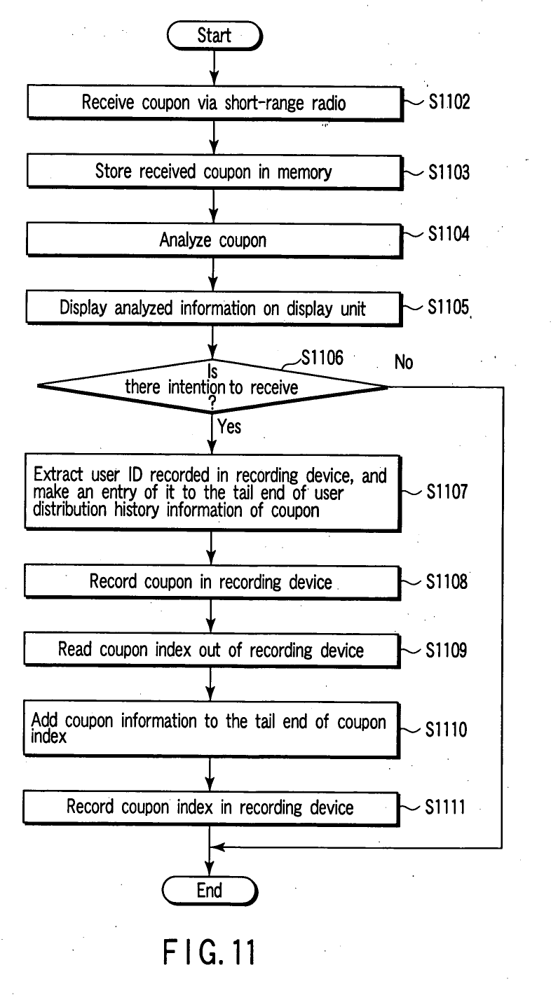

Next, a flow of operations in which the portable terminal 30 receives an electronic coupon from another portable terminal 31 will be described with reference to a flowchart of FIG. 11.

When the electronic coupon 7 is distributed from the short-range radio 315 of the portable terminal 31 in a standby mode of the portable terminal 30, the portable terminal 30 receives the electronic coupon 7 via the short-range radio 305, and stores it temporarily in the memory 302 in steps S1102 and S1103. In step S1104, the CPU 301 analyzes the electronic coupon 7, and extracts the target article name 712, the discount 713, and the expiration date 714 which are included in the coupon information 71. In step S1105, these information are displayed on the display unit 307. This makes it possible to confirm whether or not the owner of the portable terminal 30 intends to receive the electronic coupon 7. The confirmation screen is made to be a screen which is the same as that of FIG. 13. When, in step S1106, the owner of the portable terminal 30 inputs an instruction showing the intention to receive the electronic coupon 7 by operating the input unit 307 (Yes in step S1106), in steps S1107 and S1108, the user ID 3001 recorded in the recording device 303 is extracted, and the electronic coupon 7 is recorded in the recording device 303 after the user ID is added to the tail end of the user distribution history information 72 of the electronic coupon 7 temporarily stored in the memory 32. Further, in steps S1109 to S1111, the coupon index 8 is read out of the recording device 303, the coupon information 71 of the electronic coupon 7 is added to the tail end, and the coupon index 8 is recorded in the recording device 303 again. More specifically, the coupon index 8 is read out of the recording device 303 in step S1109. In step S1110, the coupon information 71 of the electronic coupon 7 is added to the tail end. In step S1111, the coupon index 8 is recorded in the recording device 303 again. In case of NO in S1106, the routine is completed.

By repeating operations as described above, a user ID is added to the tail end of the user distribution history information 72 of the electronic coupon 7 every time the electronic coupon 7 is transmitted to another portable terminal among the portable terminals 30 to 34 from any one of the portable terminals 30 to 34, so that a history of the user ID is generated in the electronic coupon 7.

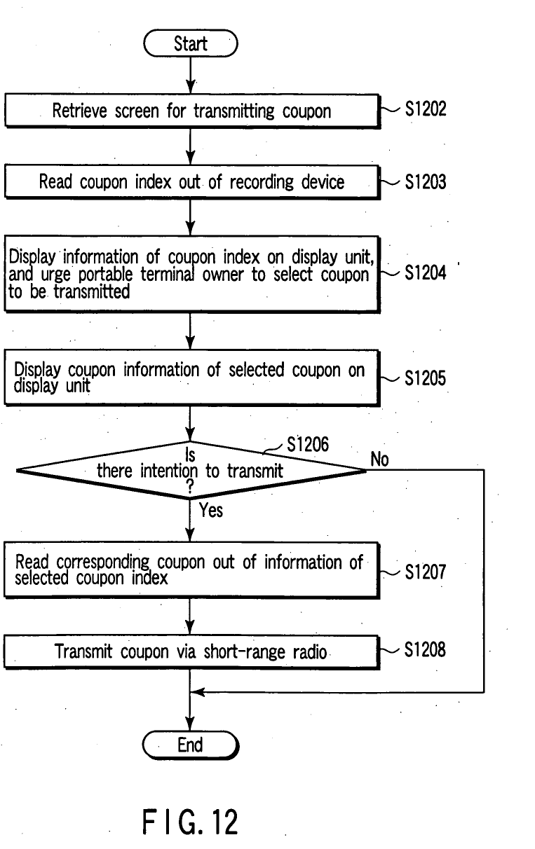

Next, a flow of operations in which the portable terminal 30 transmits the electronic coupon 7 to the POS terminal 4 to use the electronic coupon 7 will be described with reference to a flowchart of FIG. 12.

In a standby mode of the portable terminal 30, a screen for transmitting the electronic coupon 7 is retrieved on the basis of an operation of the input unit 307 by the owner of the portable terminal 30 in step S1202. In steps S1203 and S1204, the coupon indices 8 recorded in the recording device 303 are retrieved, and all or some of the coupon indices 8 read out of the recording device 303 are displayed on the display unit 306 as shown in FIG. 14 when a plurality of types of electronic coupons are stored in the portable terminal 30. A screen for causing the owner of the portable terminal 30 to select an electronic coupon to be transmitted is displayed on the display unit 306. This makes it possible to urge the portable terminal owner to select a coupon to be transmitted. If the electronic coupon 7 to be transmitted is selected when the owner of the portable terminal 30 operates the input unit 307, a screen for confirming whether or not there is the intention to transmit the electronic coupon 7 is displayed in step S1205, as shown in FIG. 15, on the display unit 306 on the basis of the information of the coupon index 8. When, in step S1206, an instruction showing the intention to transmit the electronic coupon 7 is inputted on the basis of an operation of the input unit 307 by the owner of the portable terminal 30 (Yes in step S1206), in steps S1207 and S1208, the electronic coupon 7 is read out of the recording device 303 on the basis of a coupon ID recorded in the coupon index 8, and the electronic coupon 7 is transmitted to the short-range radio 44 of the POS terminal 4 via the short-range radio 305. Thereafter, information on the settlement is recorded as settlement record in the recording device 303 in the same way as in the usual POS terminal.

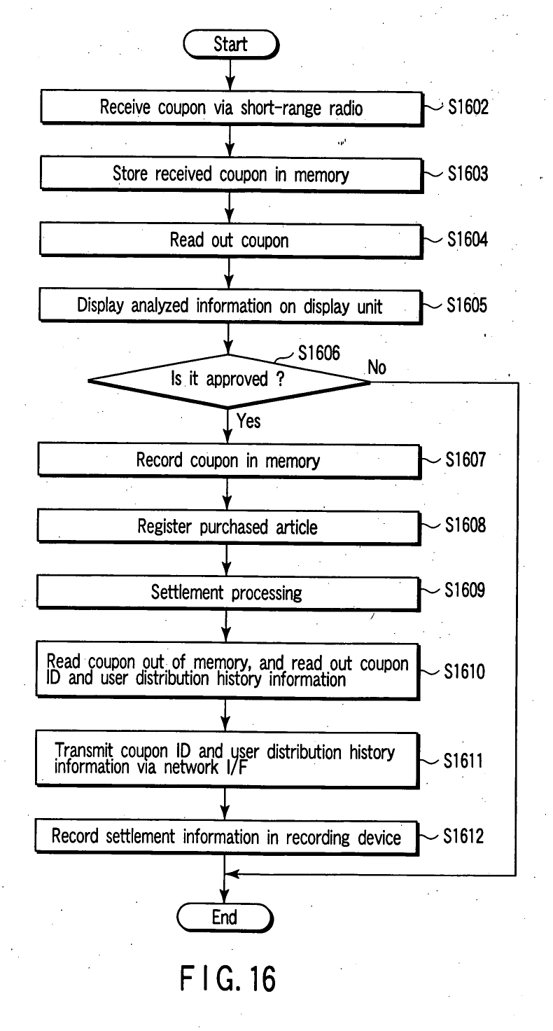

Next, a flow of operations in which the POS terminal 4 receives the electronic coupon 7 from the portable terminal 30, and transmits data included in the electronic coupon 7 to the store computer 5 will be described with reference to a flowchart of FIG. 16.

When, in a standby mode, the electronic coupon 7 is transmitted to the short-range radio 44 from the short-range radio 305 in step S1602, the POS terminal 4 temporarily stores it in the memory 42 in step S1603, and reads the coupon information 71 out of the stored electronic coupon 7. In step S1604, the target article name 712, the discount 713, and the expiration date 714 are read out of the coupon information 71. In step S1605, a screen for causing an operator of the POS terminal 4 to confirm whether or not it is allowed to use the electronic coupon 7 on the basis of the information is displayed on display unit 46. In step S1606, it is determined whether or not the receiving processing is allowed by the operator of the POS terminal 4. In step S1607, the electronic coupon 7 is temporarily recorded in the memory 42 in a state of being allowed to use. Thereafter, in step S1608, the operator of the POS terminal 4 carries out usual article registration by operating the input unit 47, and carries out settlement at the last in step S1609. In step S1610, the electronic coupon 7 is read out of the memory 42, and in step S1611, the coupon ID 711 recorded in the coupon information 71 and the user distribution history information 72 are transmitted to the in-store LAN via the network interface 45. Those are transmitted to the network interface 54 of the store computer 5 connected to the in-store LAN in the same way. Then, in the same way as in a usual settlement operation, the settlement information is recorded in the recording device 43 in step S1612.

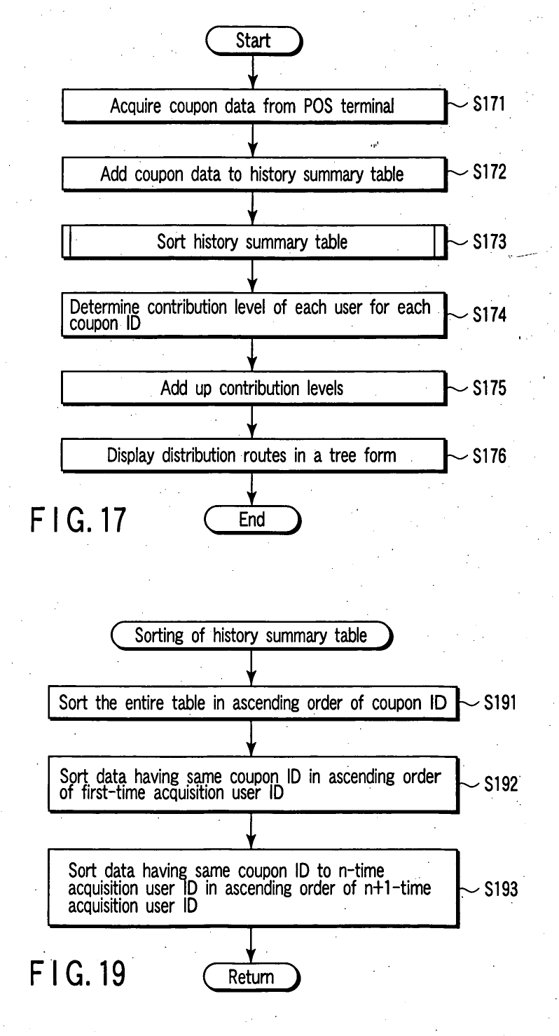

The main obligation of the store computer 5 in this system is to calculate a contribution level for each coupon ID 711, and to display a distribution route of the electronic coupon 7. The outline of the processings to be executed by the store computer 5 is shown in FIG. 17.

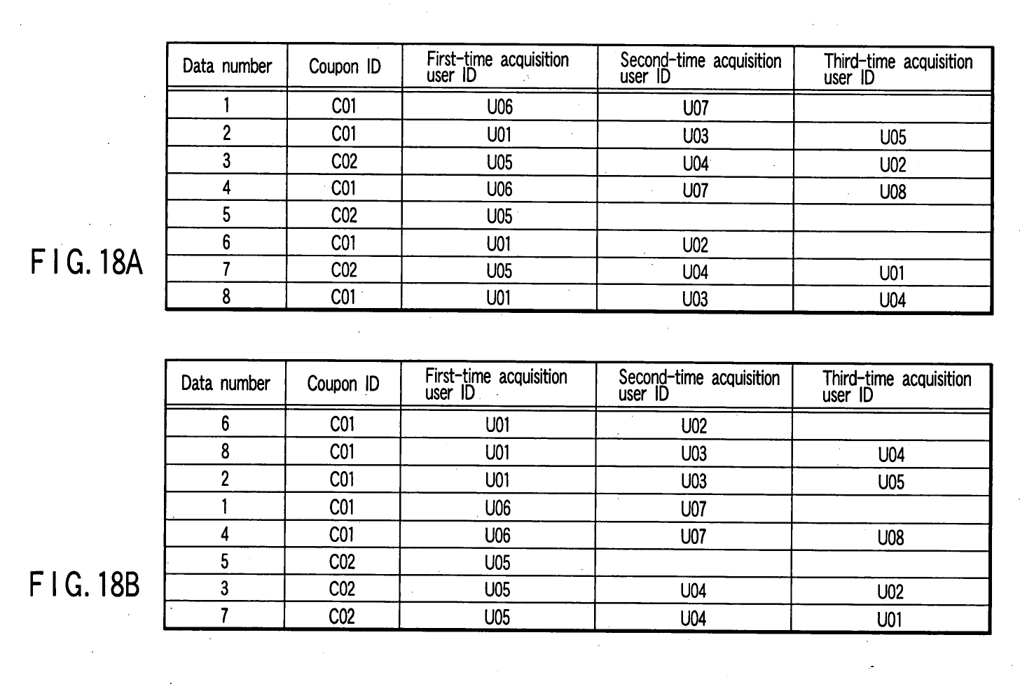

The store computer 5 receives the electronic coupon data from the POS terminal 4 via the in-store LAN (S171), and adds those to the history summary table (S172). The history summary table is a table in which the electronic coupon data received from the POS terminal 4 are recorded in order, and for example, it is made to be in a form as shown in FIG. 18A.

Subsequently, the store computer 5 sorts the history summary table by array means (S173). This is processing for making the electronic coupon data which are in disorder easy to be handled, and more specifically, the processing follows the processings of FIG. 19. Namely, as shown in FIG. 19, first, the electronic coupon data are sorted in ascending order of the coupon IDs 711 with respect to the entire history summary table (S191). Then, information having the same coupon ID 711 are sorted in ascending order of the first-time acquisition user IDs (S192). Moreover, information having the same coupon ID 711 to n-time acquisition user ID are sorted in ascending order of n+1-time acquisition user IDs (S193). In accordance with this sorting, FIG. 18A is sorted in ascending order of the coupon IDs, and in ascending order of the user IDs as shown in FIG. 18B.

After the history summary table is sorted, the store computer 5 obtains a contribution level of each portable terminal owner for each ID 711 (S174). Hereinafter, suppose that portable terminal owners who have purchased an article by use of an electronic coupon are purchasers, and portable terminal owners other than the purchasers in a distribution history are introducers. As expressions for obtaining a contribution level, for example, the following expressions are used.

Given that

“a” is weighting factor of contribution level,

“n” is a number of introducers, and

n=0,

(contribution level of purchaser)=1.

Given that n≧1,

(contribution level of purchaser)=a,

(contribution level of i-time introducer)=a(1−a)ˆ(n−i+1), and

(contribution level of first-time introducer)=(1−a)ˆn.

In the above-described expressions, the closer to a purchaser the someone is, the higher the contribution level is, and contribution levels in one distribution history are added up to 1 in total.

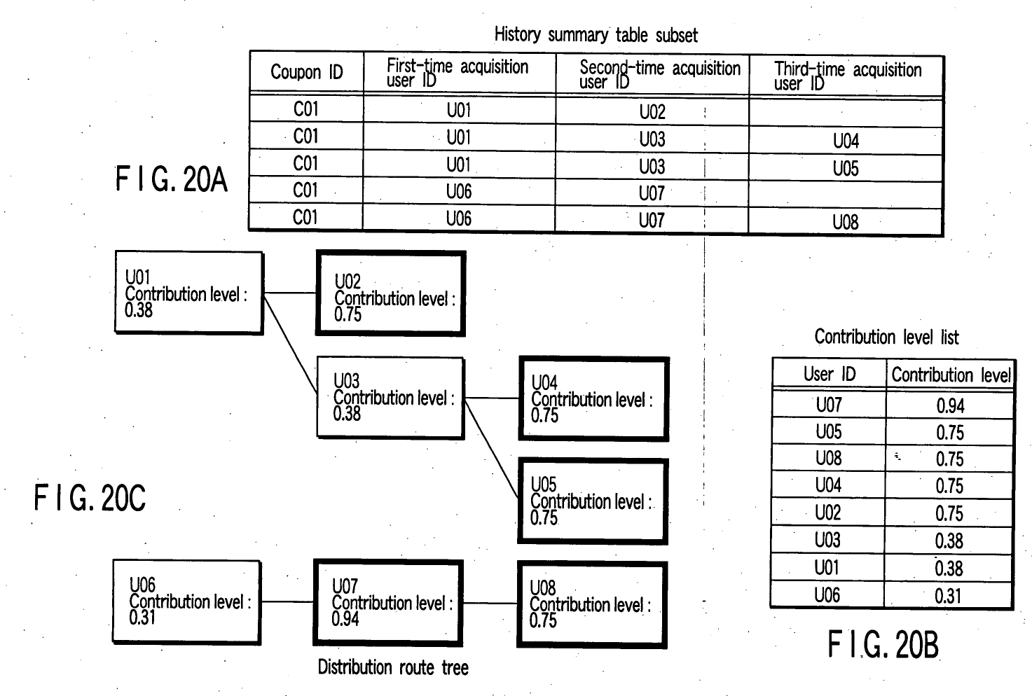

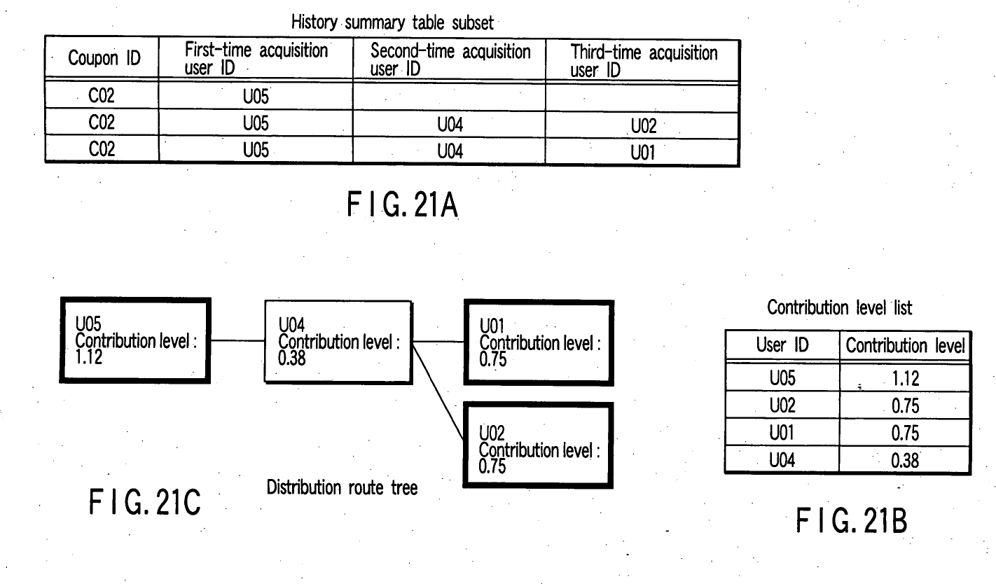

Provided that contribution levels of the respective portable terminal owners are determined for each line of FIG. 18B by using the above expressions, and the contribution levels having the same coupon ID 711 are added up by adding-up means (S175), contribution levels of the respective portable terminal owners for each coupon ID 711 are determined. When those are sorted in descending order of the contribution levels of the portable terminal owners, a contribution level ranking table (contribution level list) as shown in FIG. 20B or 21B can be obtained.

By the way, it is possible to find a user at a high contribution level from this contribution level ranking table. However, it is difficult to read what positioning the user is in the distribution route by only the contribution level ranking table. In order to read a positioning in this distribution route, a tree view of a distribution route as shown in FIG. 20C or 21C is utilized.

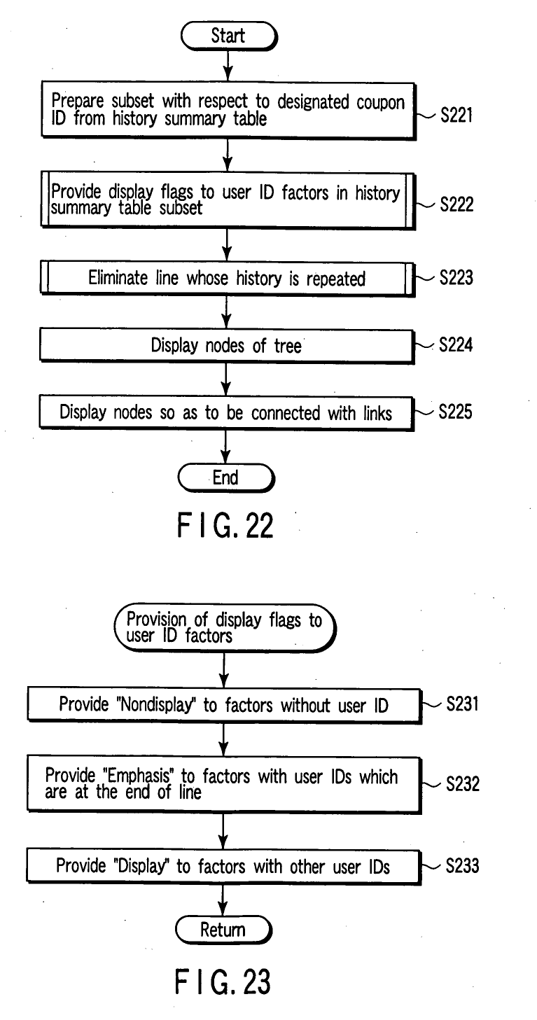

After contribution levels of the respective users are determined, the store computer 5 shows a coupon distribution route in a tree view for each coupon ID 711 (S176). The tree view of a distribution route follows processings of FIG. 22.

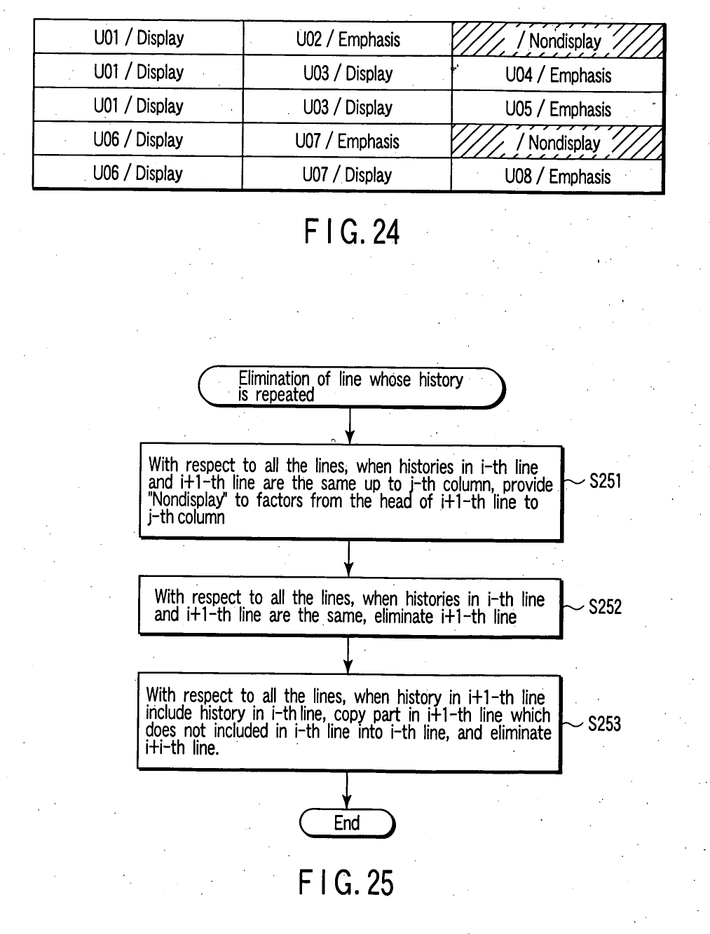

As shown in FIG. 22, a subset with respect to a designated coupon ID 711 is prepared (S221) from a sorted history summary table (FIG. 18B), and then a tree for each coupon ID 711 is prepared on the basis of the history summary table subset (FIG. 20A, FIG. 21A). In order to prepare a tree from a history summary table subset, first, display flags are provided to respective elements in the history summary table subset (S222). This provision of display flags follows a flow of FIG. 23 specifically. As shown in FIG. 23, “nondisplay” is provided to the elements without user ID (S231), “emphasis” is provided to the elements with user IDs which are the end in the line (S232), and “display” is provided to the elements with the other user IDs. In this way, the history summary subset to which the display flags have been provided is as shown in FIG. 24. FIG. 24 is a table showing a history summary subset to which display flags have been provided. As shown in FIG. 24, the flags of nondisplay are provided to the elements without user IDs being displayed among the elements, the flags of emphasis are provided to the elements in which the user IDs are displayed and which are at the end of the lines, and the flags of display are provided to the other elements.

After the display flags are provided, the store computer 5 eliminates lines in which the histories are overlapped on the history summary table subset (S223). This processing of elimination follows a flow of processings of FIG. 25. To follow the changes in the history summary table subset in case of following the flow of the processings, it is as follows.

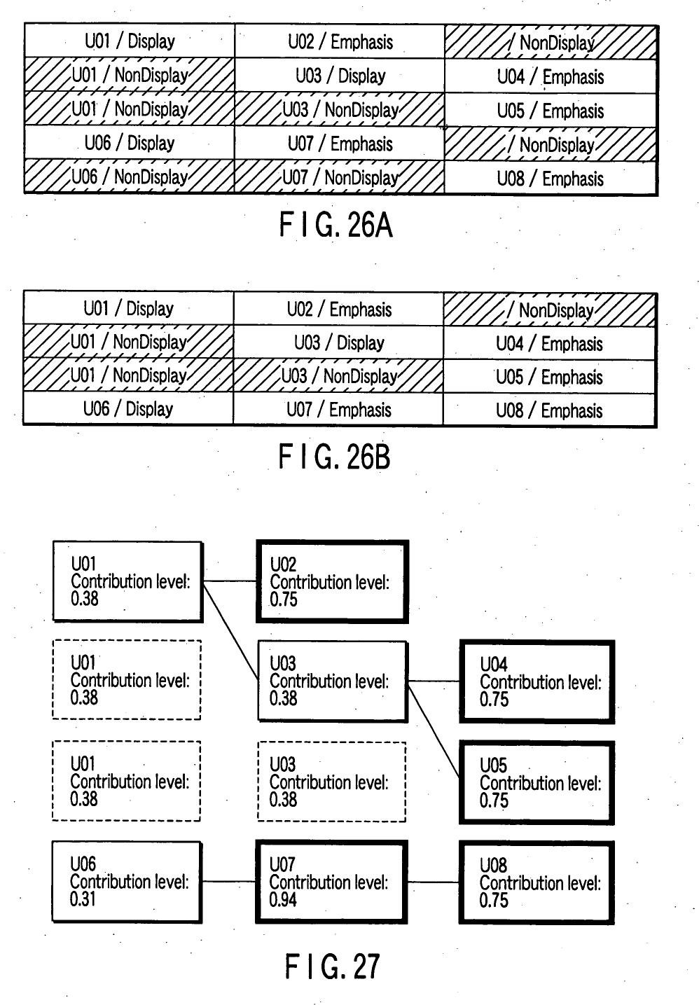

As shown in FIG. 25, first, in S251, given that i=1 and j=1, (2, 1) is nondisplay because of (1, 1)=U01 and (2, 1)=U01. In the same way, given that i=2 and j=2, (3, 1) and (3, 2) are nondisplay, and given that i=4 and j=2, (5, 1) and (5, 2) are nondisplay. In accordance with this processing, the history summary table subset of FIG. 24 is as shown in FIG. 26A.

Next, in S252, lines having the completely same history are eliminated from the history summary table. Because there is no line having the completely same history in the history summary table subset of FIG. 26A, nothing in the table changes.

At the last, according to S253, considering that the history in the fifth line of FIG. 26A includes the history in the fourth line, an element (5, 3) which is in the fifth line, but is not in the fourth line is copied to (4, 3) and the fifth line is eliminated, so that the history summary table subset is made to be as shown in FIG. 26B.

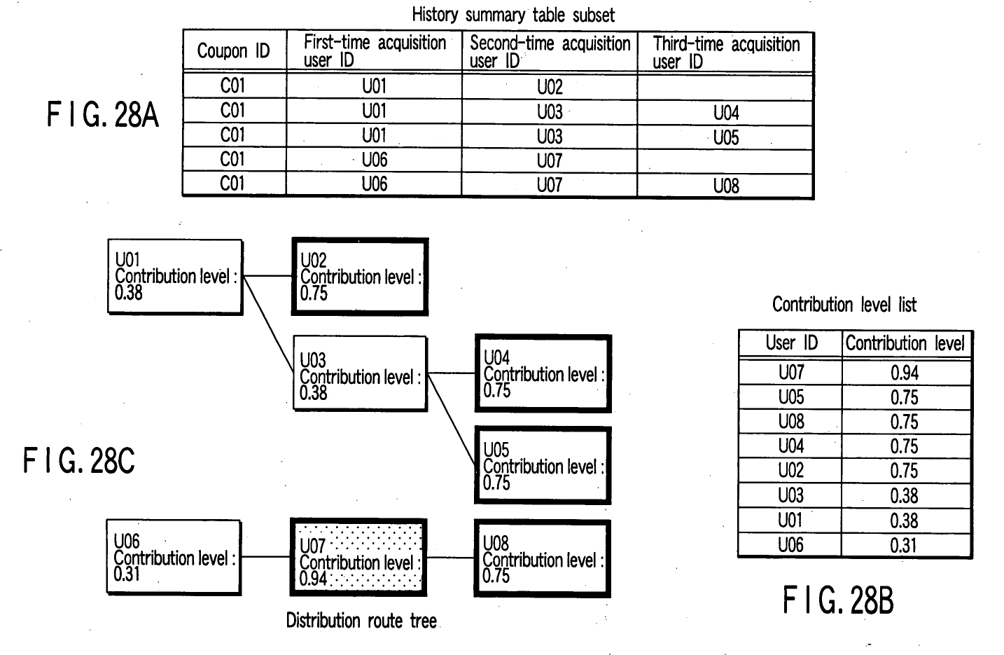

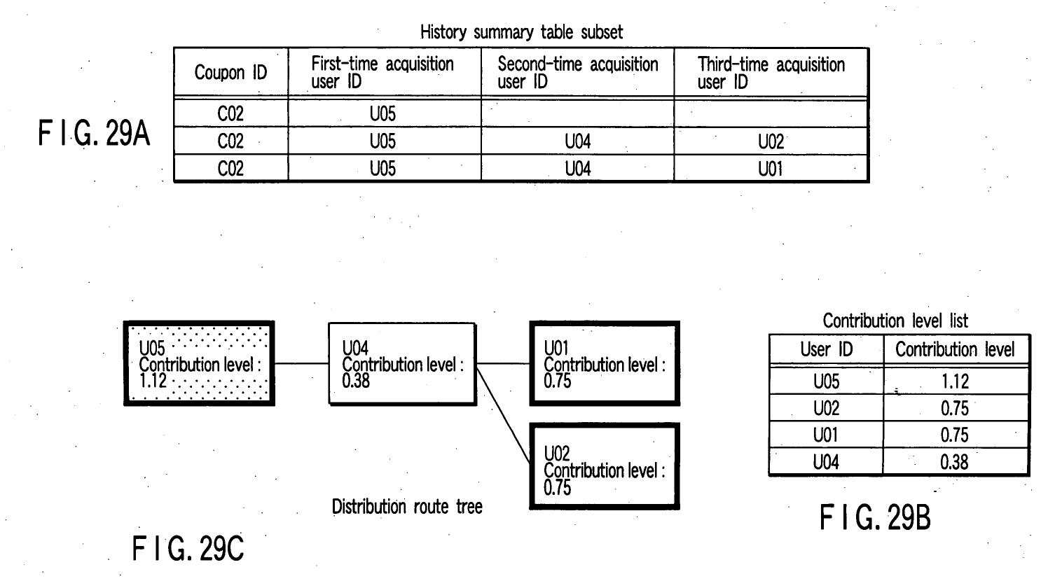

After a line having an repeated history is eliminated from the history summary table subset, the store computer 5 displays the elements in which the display flags are not “nondisplay” among the respective elements in the history summary table subset, as nodes (S224). Here, with respect to the elements in which the display flags are “emphasis”, a position of a purchaser in the tree is made easy to be grasped in such a manner that the frames of the nodes are brought into clear view so as to be heavy lines or to be colored. Here, the display frames in the tree are displayed with heavy lines. At the same time, the elements with the user IDs at the top of FIGS. 20B and 21B (i.e., users at the highest contribution level) as well are brought into clear view separately from a purchaser so as to paint out the insides of the nodes with a striking color, or the like. For example, it may be brought into clear view such that fine dots are displayed in the tree as shown in FIGS. 28C and 29C. A user ID and a contribution level of the user are displayed in each node, which makes it easy to grasp how the contribution levels have been provided.

At the last, the displayed nodes are connected with links (S225). The links take nodes in the right and lower right directions from among the displayed nodes as candidates for destinations to be connected. The links are connected from a focused node to some of these candidates that have an equivalent part of history which is prior to the focused nodes. FIG. 27 illustrates a tree obtained from the history summary table subset of FIG. 26B. Here, the nodes surrounded with dashed-lines are nodes in which the display flags are “nondisplay” in the history summary table subset, and are not displayed in a practical sense. Connecting the nodes with links completes the tree views in FIGS. 20C and 21C showing distribution routes of the electronic coupon distribution history which are described above.

In accordance with the flows of the above processings, the store computer 5 can acquire electronic coupon data from the POS terminal 4 to tabulate the contribution levels, thereby showing the distribution history in a tree view by display means. Namely, it is possible to display the user IDs arrayed in a tree form, which has a user ID added at the beginning of a history as a root, of accumulated user IDs as a distribution history of the electronic coupons, along with those contribution levels on the display unit 55.

Note that, in the tree views of the distribution routes shown in FIGS. 20C and 21C, the thicknesses of the frame lines for displaying the user IDs added to the electronic coupons 7 at the end and the contribution levels corresponding to the IDs are displayed so as to be different from the frame lines for displaying user IDs and the contribution levels of the others. More specifically, as shown in the drawings, the thicknesses of the frame lines for displaying the user IDs added to the electronic coupons 7 at the end and the contribution levels corresponding to the IDs are displayed so as to be thicker than the frame lines for displaying user IDs and the contribution levels of the others. Note that the user ID added to the electronic coupons 7 at the end is one for the portable terminal used for purchasing an article. Therefore, the thicknesses of the frame lines for displaying the user IDs added to the end of the electronic coupons 7 and the contribution levels corresponding to the IDs are made different from those for displaying of the other user IDs and the contribution levels, whereby trusted customers who distribute electronic coupons and use the coupon by themselves can be signalized among the customers in a tree of distribution routes.

The present embodiment has described the case where the thicknesses of the frame lines for displaying the user IDs added to the end of the history of the electronic coupons 7 and the contribution levels corresponding to the IDs are different from the thicknesses of the frame lines for displaying user IDs and the contribution levels of the others, but the way to distinguish the specific user ID and contribution level is not limited to the case. For example, the character style, the size of characters, the color of characters, and the color of frame lines in display of the user IDs added to the end of the history of the electronic coupons 7 and the contribution levels corresponding to the IDs may be displayed so as to be different from those of the other user IDs. Further, the thickness of frame lines, the character style, the size of characters, the color of characters, and the color of frame lines in display may be combined. Namely, one or more of the character style, the size of characters, the color of characters, the thicknesses of frame lines, and the color of frame lines in display of the user IDs added to the end of the history of the electronic coupons 7 and the contribution levels corresponding to the IDs may be displayed so as to be different from those of the other users.

Further, in the tree of distribution routes, the display of a user ID and a contribution level at a highest contribution level is indicated so as to add fine dots as shown in FIGS. 28C and 29C. This makes it possible to show a customer at a highest contribution level in the tree of distribution routes, and also makes it possible for an operator to immediately find the customer at a highest contribution level relating to the sales of the articles. Further, a method for displaying a customer at a highest contribution level is not limited to a display in which fine dots are added. The character style, the size of characters, the color of characters, and the color of frame lines of only a customer at a highest contribution level in the display in the tree may be displayed so as to be different from those of the other customers.

The present embodiment has described the case where the function of executing the invention has been recorded in the apparatus in advance, but not limited thereto. The same function may be downloaded from a network to the apparatus, and a recording medium on which the same function has been stored may be installed in the apparatus. As such a recording medium, a recording medium such as a CD-ROM, on which programs can be stored, and which is readable by the apparatus may be in any form. Further, a function which can be obtained in advance by installation or downloading may be achieved in cooperation with an operating system (OS) or the like in the apparatus.

Note that the present invention is not limited to the embodiment described above as is, and at the stage of implementing the invention, the constitutional elements can be modified and embodied within a range which does not deviate from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic coupon system comprising: a plurality of portable terminals which are configured to communicate with one another and which have identification information for specifying users; a server configured to communicate with the portable terminals via a network; a POS terminal configured to communicate with the portable terminals via a short-range radio; and an information terminal configured to communicate with the POS terminal via a network, wherein
the server comprises means for issuing electronic coupons, the portable terminals each comprise means for receiving the electronic coupons issued by the server; means for transmitting and receiving the electronic coupons among the portable terminals; means for newly adding identification information to the electronic coupons every time the portable terminals receive the electronic coupons; the POS terminal comprises means for receiving an electronic coupon to which at least one of the identification information has been added, from the portable terminals; the POS terminal comprises means for acquiring identification information from the electronic coupons, the information terminal comprises means for receiving and storing identification information for said each electronic coupon from the POS terminal; the information terminal comprises means for arraying the stored identification information in order of adding to the electronic coupons for said each electronic coupon; the information terminal comprises means for displaying the arrayed identification information; and means for calculating contribution levels of users who have used the electronic coupons on the basis of the arrayed identification information.

2. A contribution level calculation system of an electronic coupon processing device configured to communicate via a network with a settlement processing device configured to communicate via a short-range radio with a plurality of portable terminals which are configured to communicate with one another and which have identification information for specifying users, the contribution level calculation system comprising:
means for receiving history information and unique information which have been extracted by the settlement processing device from an electronic coupon in which at least the unique information for specifying the electronic coupon is stored along with the history information in which the identification data are added as a history at the time of being transmitted and received among said plurality of portable terminals;
means for recording the received history information and unique information so as to be associated with each other;
means for sorting and arraying the stored history information and unique information in a predetermined order;
means for calculating contribution levels of said plurality of portable terminals with respect to electronic coupons used for settlement in the settlement processing device on the basis of the arrayed history information and unique information;
means for adding up the calculated contribution levels with respect to all of the stored history information and unique information for said each identification information; and
means for displaying the identification information arrayed in a tree form with identification information stored at the start in the electronic coupon among the identification information added as a history to the history information being as a root, along with contribution level information showing a contribution level of said each added-up identification information.

3. The contribution level calculation system according to claim 2, wherein with respect to the arrayed identification information, the means for calculating contribution levels provides a first value to identification information added to the electronic coupon at the end; when there is identification information which is adjacent to the identification information having the first value provided thereto, and which has been added to an electronic coupon previously, provides a second value obtained by multiplying the first value by a given ratio to the adjacent identification information; changes a value obtained by subtracting the second value from the first value to a first value, and determines the changed first value and the second value to be contribution levels of a user specified by the identification information to which the respective values have been provided.

4. The contribution level calculation system according to claim 3, wherein, when the identification information having the second value provided thereto is the identification information that is added to the electronic coupon at the end previously, a value obtained by adding the first value and the second value is determined to be a contribution level of the identification information.

5. The contribution level calculation system according to claim 3, wherein, when there is identification information which is adjacent to the identification information having the second value provided thereto, and which has been added to an electronic coupon previously, a contribution level calculation is carried out with the second value being as the first value.

6. The contribution level calculation system according to claim 5, wherein, when the identification information having the second value provided thereto is the identification information that is added to the electronic coupon at the end previously, a value obtained by adding the first value and the second value is determined to be a contribution level of the identification information.

7. The contribution level calculation system according to claim 3, wherein, when a plurality of the second values are provided to the identification information, a value obtained by adding all the second values is determined to be a contribution level of the identification information.

8. An electronic coupon processing device configured to communicate via a network with a settlement processing device configured to communicate via a short-range radio with a plurality of portable terminals which are configured to communicate with one another and which have identification information for specifying users, the electronic coupon processing device comprising:
receiving means for receiving history information and unique information which have been extracted by the settlement processing device from an electronic coupon in which at least the unique information for specifying the electronic coupon is stored along with the history information in which the identification data are added as a history at the time of being transmitted and received among said plurality of portable terminals;
storing means for storing the history information and the unique information which have been received by the receiving means so as to be associated with each other;
arraying means for sorting and arraying in a predetermined order the history information and the unique information which have been stored in the storing means;
contribution level calculating means for calculating contribution levels of said plurality of portable terminals with respect to electronic coupons used for settlement in the settlement processing device on the basis of the history information and the unique information which have been arrayed by the arraying means;
adding-up means for adding up the contribution levels calculated by the contribution level calculating means for said each identification information with respect to all of the history information and the unique information stored in the storing means; and
display means for displaying the identification information arrayed in a tree form with identification information stored at the start in the electronic coupon among the identification information added as a history to the history information being as a root, along with contribution level information showing a contribution level of said each identification information added up by the adding-up means.

9. The electronic coupon processing device according to claim 8, wherein, with respect to the identification information and the contribution level information which are displayed in a tree form by the display means, any one or more of a character style, a size of characters, a color of characters, a thickness of frame lines, and a color of frame lines of display of the identification information added as a history to the electronic coupon at the end and the contribution level information are displayed so as to be different from a character style, a size of characters, a color of characters, a thickness of frame lines, and a color of frame lines of display of the other identification information and contribution level information.

10. An electronic coupon processing program which causes a computer to realize:
a function of receiving history information and unique information which have been extracted by a settlement processing device from an electronic coupon in which at least the unique information for specifying the electronic coupon is stored along with the history information in which, at the time of being transmitted and received among a plurality of portable terminals which are configured to communicate with one another and which have identification information for specifying users, the identification information are added as a history;
a function of storing the received history information and unique information so as to be associated with each other;
a function of sorting and arraying the stored history information and unique information in a predetermined order;
a function of calculating contribution levels of said plurality of portable terminals with respect to electronic coupons used for settlement in the settlement processing device on the basis of the arrayed history information and unique information;
a function of adding up the calculated contribution levels for said each identification information with respect to all of the history information and the unique information which have been stored; and
a function of displaying the identification information arrayed in a tree form with identification information stored at the start in the electronic coupon among the identification information added as a history to the history information being as a root, along with contribution level information showing a contribution level of said each added-up identification information.

11. The electronic coupon processing program according to claim 10, wherein, with respect to the identification information and the contribution level information to be displayed, any one or more of a character style, a size of characters, a color of characters, a thickness of frame lines, and a color of frame lines of display of the identification information added as a history to the electronic coupon at the end and the contribution level information corresponding to the identification information are displayed so as to be different from a character style, a size of characters, a color of characters, a thickness of frame lines, and a color of frame lines of display of the other identification information and contribution level information.
